(19) United States
(12) Patent Application Publication
(10) Pub. No.: US 2026/0002851 A1
(43) Pub. Date: Jan. 1, 2026

(54) METHODS AND APPARATUS FOR A MECHANICAL TESTING SYSTEM TO CHARACTERIZE THE HETEROGENEOUS DEFORMATION AT MICROSCALE

(71) Applicants: Ajit Achuthan, Potsdam, NY (US); Natasha K. Banerjee, Potsdam, NY (US); Sean Banerjee, Potsdam, NY (US); Janith Wanni, Potsdam, NY (US); Kavindu Wijesinghe, Potsdam, NY (US)

(72) Inventors: Ajit Achuthan, Potsdam, NY (US); Natasha K. Banerjee, Potsdam, NY (US); Sean Banerjee, Potsdam, NY (US); Janith Wanni, Potsdam, NY (US); Kavindu Wijesinghe, Potsdam, NY (US)

(73) Assignee: CLARKSON UNIVERSITY, POTSDAM, NY (US)

(21) Appl. No.: 18/756,582

(22) Filed: Jun. 27, 2024

(51) Int. Cl. G01N 3/08; G01N 3/06

(52) U.S. Cl. CPC G01N 3/08; G01N 3/068; G01N 2203/0647

(57) ABSTRACT

A method, apparatus, and software for an in-situ mechanical testing system to characterize heterogeneous deformation at microscale are disclosed. The current intellectual property landscape shows the in-situ mechanical testing of metals and alloys is severely limited to a maximum of about 1% macroscopic strain due to the optical microscopy's low depth of focus. To address this challenge, we disclose a smart imaging system consisting of several novel techniques. The techniques include digitally enhanced effective depth of field, real-time targeting and maintaining of a region of interest to image within the field of view and focus, and a panoramic imaging method to digitally widen the field of view. We also disclose a deformation quantification subsystem to analyze the collected data and quantify deformation characteristics. Finally, an expert system to extract the influence of microstructural features on the elastic-plastic and fracture properties is also disclosed.

### GOVERNMENT FUNDING

This invention was made with Government support under Grant Number 2016529 awarded partly by the National Science Foundation (NSF) and NASA. The United States Government does not have any rights in the invention.

### FIELD OF THE INVENTION

The present disclosure is directed generally to methods and apparatus for a mechanical testing system to characterize heterogeneous deformation at microscale in-situ.

### BACKGROUND

Experimental characterization of the mechanical behavior of materials at various length scales is a critical need in various engineering applications. For metals, and alloys in particular, where crystallographic grains effectively being the building block of the material in terms of its mechanical behavior, the characterization of material response at a length scale in the order of the size of crystallographic grains is fundamental to the understanding of these materials. These grains are typically in the range of a few microns to tens of microns in size. Therefore, a testing method that can characterize the mechanical deformation at microscopic length scale under uniaxial tensile, compressive, or bending loading, especially optical based that allow direct visualization of evolution of these features using digital means, would be an extremely useful investigative tool. Currently, in-situ SEM is the only method that allows direct visualization of large-scale deformation at micro-and sub-micro length scales. Optical imaging platforms, due to their inherent low depth of field, are limited to a maximum of 1% macroscopic stain when most metal samples undergoes 20 to 100% strain before its failure. This limitation is due to the low depth of field of the optical microscopes, and if mitigated, will have several advantages over in-situ SEM as listed below. Likewise, DIC is the only method that can quantitively determine deformation, which also has limitations as listed below. Finally, there is no reliable technique to derive the characteristics of the influence of microstructural features on the material's deformation from the evolution of deformation collected in the series of hundreds of image frames (video), which is currently performed by manually sifting through individual frames.

While SEM allows for higher resolution and greater magnification than optical methods, its field of view is typically limited. Optical imaging, with its larger field of view, could be more beneficial for examining relatively large microscale features in the range of a few microns to tens of microns. In many conventionally manufactured metals and alloys, as well as those produced through additive manufacturing (AM) using powder jet or wire technologies, the microstructural features of interest—such as grains (typically on the order of 10s of microns) and sub-grain cellular structures (a few microns)—fall within the imaging capabilities of an optical microscope. The characteristic length scale of the microstructural feature-influenced deformation, which governs the elastic-plastic and failure properties, also falls within the imaging capabilities of optical microscopy. Even for the parts prepared by powder jet AM technologies, which may exhibit sub-grain features of the order of about a micron, feature-influenced deformations are expected to be revealed within the realm of optical microscopy. The necessary field of view required to capture these important characteristics is relatively large, for which the SEM has to be operated at lower magnifications, where image quality of SEM drops substantially.

SEM testing is more time consuming, difficult, and very expensive, especially to perform an in-situ mechanical testing. Installing the apparatus requires the entire SEM to be vented each time a measurement is made and any vacuum leaks that result from this will severely shorten the lifetime of the emission gun. In addition, SEM is susceptible to debris formed during the testing and could lead to very expensive system failures. Setting up an SEM for in-situ testing requires substantial background knowledge in SEM as well.

Another significant drawback of using SEM for in-situ mechanical applications is its inability to operate continuously during progressive loading and deformation of the specimen. This limitation arises due to the considerable time SEM requires to generate an image, as scanning is a relatively slow process. Consequently, loading must be intermittently paused to allow for scanning to be performed and completed at each load level before progressing to the next. This poses a serious constraint, particularly when testing materials that are sensitive to loading rates.

DIC is currently the only method available for extracting quantitative information related to deformation from in-situ videos. In the traditional DIC method, microscopic strain fields are computed from the deformation field information gathered from the motion of the speckle pattern deposited on the specimen surface. However, this approach presents two major drawbacks: 1) speckle patterns obscure the visibility of underlying microstructural features, making it challenging to establish a direct correlation between a feature and the deformation around it, which is critical for determining the influence of microstructural features on the deformation, and 2) the strain fields derived from DIC do not encompass information regarding local microscopic rigid body rotations, which are also essential for understanding the influence of microstructural features on deformation. Although the first drawback can be partially mitigated by exposing microstructural features through chemical etching of the surface and utilizing them instead of imprinted speckle patterns, the traditional DIC method remains severely limited by the second drawback.

The traditional approach of manually sifting through individual frames to extract the characteristics of the influence of microstructural features on the material's deformation from the evolution of deformation collected in the series of hundreds of image frames has severe limitations. Being manual, the process is enormously time-consuming and error prone. The deformation pattern contained in each frame is generally very complex, to the extent that even experts with extensive experience may overlook or misinterpret crucial characteristics such as deformation localization, slip band evolution, crack initiation, and crack propagation.

In short, there is a critical need for an in-situ mechanical testing method with an optical-based imaging platform capable of directly capturing the deformation of a specimen over a large macroscopic strain range without the interference of speckle patterns. Additionally, there is a need for an expert system to extract and analyze the deformation characteristics embedded within the stack of images.

Accordingly, there is a need in the art for improved methods and apparatus for a mechanical testing system to characterize heterogeneous deformation at microscale in-situ.

### SUMMARY

According to an aspect, the present disclosure is related to a mechanical testing system for characterizing heterogeneous deformation at microscale in-situ, comprising a specimen on which the testing is conducted and having a bottom surface including a representative microscopic region thereon and a top surface with reference markings formed thereon; a load imparting device such as a microtensile tester for imparting a load to the specimen to which the specimen is mounted; an inverted microscope adapted to capture data representative of local deformations formed in the representative microscopic region of the specimen as it undergoes the loading imparted by the device; a camera for digitally capturing a stream of image data at the top surface to track the reference marking, wherein the motion of the reference marking is representative of the macroscopic strain of the specimen as it undergoes the loading imparted by the device; an adjustment device adapted to move the load imparting device along with the mounted specimen; and a controller having a non-transitory memory and programmed, configured, and/or structured to control movement of the adjustment device; process the image data captured by the camera and quantify the macroscopic strain of the specimen; process the image data captured by the microscope to quantify the drift of the target microscopic representative region from the field of view horizontally; instruct the adjusting device to perform the needed adjustment horizontally to maintain the target imaging region within the field of view following a closed loop control architecture using the calculated drift information from the image data as feedback; drive the continuous cyclic motion of the adjustment device to vary the object distance between the imaging surface and objective lens to capture images from different object distances that contain different partial regions under focus; process the image data captured by the microscope at different object distances to quantify the sharpness in the image; drive the adjustment device to perform the needed adjustment vertically to maintain the target imaging region within focus following a closed loop control architecture using the sharpness information as feedback; perform the stacking of the images obtained under vertical motion to build high quality frames of fully focused images; drive the adjustment device to perform pre-determined horizontal motion to capture panoramic imaging as needed; perform stitching of the images obtained under horizontal motion to obtain large panoramic views as needed; perform the data analysis of the generated images to determine evolution of various underlying characteristics of the local deformation such as microscopic local strain field, rigid body rotations, slip bands, crack initiations, and crack propagations and the deformation of individual microstructural features; and simulate the expert system to analyze the determined evolution characteristics and determine the influence of the microstructure and its features on the local microscopic deformation, and elastic-plastic and failure properties.

According to an embodiment, the load imparting device can have different variations of micro-tensile devices that can impart uniaxial tension, compression, bending, or any combination of it.

According to an aspect is a method for characterizing heterogeneous deformation at microscale in-situ, comprising the steps of providing a specimen on which the testing is conducted and having a bottom surface including a representative microscopic region thereon and a top surface with reference markings formed thereon; a device such as micro-tensile tester for imparting a load to the specimen; providing an inverted microscope adapted to capture data representative of local deformations formed in the microscopic region of the specimen as it undergoes the loading imparted by the device; providing a camera for digitally capturing a stream of image data of the reference markings, wherein the motion of the reference markings is representative of the macroscopic strain caused to the specimen as it undergoes the loading imparted by the device; providing an adjustment device adapted to move the load imparting device along with the mounted specimen; controlling movement of the adjustment device; processing the image data captured by the camera and quantify the macroscopic strain of the specimen; processing the image data captured by the microscope to quantify the drift of the target microscopic representative region from the field of view horizontally; instructing the adjusting device to perform the needed adjustment horizontally to maintain the target imaging region within the field of view following a closed loop control architecture using the calculated drift information from the image data as feedback; driving the continuous cyclic motion of the adjustment device to vary the object distance between the imaging surface and objective lens to capture images from different object distances that contain different partial regions under focus; processing the image data captured by the microscope at different vertical distances to quantify the sharpness in the image; driving the adjustment device to perform the needed adjustment vertically to maintain the target imaging region within focus following a closed loop control architecture using the sharpness information as feedback; performing the stacking of the images obtained under vertical motion to build high quality frames of fully focused images; driving the adjustment device to perform pre-determined horizontal motion to capture panoramic imaging as needed; performing stitching of the images obtained under horizontal motion to obtain large panoramic views as needed; performing the data analysis of the generated images to determine evolution of various underlying characteristics of the local deformation such as microscopic local strain field, rigid body rotations, slip bands, crack initiations, and crack propagations and the deformation of individual microstructural features; and simulating the expert system to analyze the determined evolution characteristics and determine the influence of the microstructure and its features on the local microscopic deformation, and elastic-plastic and failure properties.

According to an aspect is a computer program stored in the memory of a controller having a non-volatile memory, wherein the controller is electronically connected to a system for characterizing heterogeneous deformation at microscale in-situ, that includes a specimen on which the testing is conducted and having a bottom surface including a representative microscopic region thereon and a top surface with reference markings formed thereon; a loading device such as a microtensile tester for imparting a load to the specimen; an inverted microscope adapted to capture data representative of local deformations formed in the microscopic region of the specimen as it undergoes the loading imparted by the device; a camera for digitally capturing a stream of image data of the reference markings, wherein the motion of the reference markings is representative of the macroscopic strain caused to the specimen as it undergoes the loading imparted by the device; and an adjustment device adapted to move the load imparting device along with the mounted specimen, the computer program containing computer readable instructions adapted to control movement of the adjustment device; process the image data captured by the camera and quantify the macroscopic strain of the specimen; process the image data captured by the microscope to quantify the drift of the target microscopic representative region from the field of view horizontally; instruct the adjusting device to perform the needed adjustment horizontally to maintain the target imaging region within the field of view following a closed loop control architecture using the calculated drift information from the image data as feedback; drive the continuous cyclic motion of the adjustment device to vary the object distance between the imaging surface and objective lens to capture images from different object distances that contain different partial regions under focus; process the image data captured by the microscope at different vertical distances to quantify the glare in the image; drive the adjustment device to perform the needed adjustment vertically to maintain the target imaging region within focus following a closed loop control architecture using the sharpness information as feedback; perform the stacking of the images obtained under vertical motion to build high quality frames of fully focused images; drive the adjustment device to perform pre-determined horizontal motion to capture panoramic imaging as needed; perform stitching of the images obtained under horizontal motion to obtain large panoramic views as needed; perform the data analysis of the stacked images to determine evolution of various underlying characteristics of the local deformation such as microscopic local strain field, rigid body rotations, slip bands, crack initiations, and crack propagations and the deformation of individual microstructural features; and simulate the expert system to analyze the determined evolution characteristics and determine the influence of the microstructure and its features on the local microscopic deformation, and elastic-plastic and failure properties. These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a schematic illustration of a system for characterizing heterogeneous deformation at microscale in-situ, in accordance with an embodiment.

FIG. 2 is the flow charts that describe smart imaging subsystem 100, in accordance with an embodiment.

FIG. 3 is the deformation quantification subsystem 200, in accordance with an embodiment.

FIG. 4 is the material modeling subsystem 300, in accordance with an embodiment.

### DETAILED DESCRIPTION OF EMBODIMENTS

The present disclosure describes a system, method, and computer program for characterizing heterogeneous deformation at microscale.

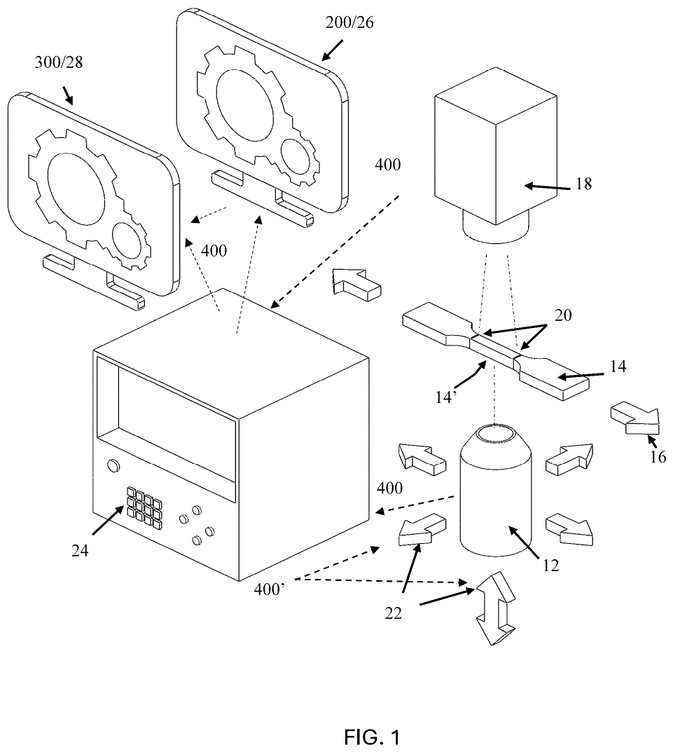

Referring to FIG. 1, in one embodiment, is shown a schematic of a simple setup 10 that illustrates the concept of an embodiment of the invention. System 10 generally comprises an inverted microscope 12 to capture the local deformation of a representative microscopic region 14′ on the bottom side of a specimen 14 subjected to mechanical loading. The mechanical loading is typically applied by a micro-tensile testing machine 16. The setup also comprises a camera 18 to determine the macroscopic strain by tracking reference lines imprinted at the ends of the gauge region 20 on the top side of the sample surface. The adjustment device 22 moves the loading device with the mounted specimen in the horizontal plane with respect to the objective lens of the microscope to continuously maintain the imaging region under the field of view of the microscope based on the instructions 400′ given by the controller following a closed loop control architecture using the calculated drift information from the image data 400 as feedback. It also moves the device in the vertical direction to maintain the imaging surface within focus following a closed loop control architecture using the calculated drift information from the image data 400 as feedback. It also moves the device in the vertical direction cyclically to generate images of the deformed region from different distances that allow image stacking. It also moves the adjusting device horizontally along a pre-determined path to capture panoramic imaging as needed; Device 24 is a controller that collects image data 400 both from the microscope and camera continuously throughout the test. Using the image data 400 from the camera, the controller computes the macroscopic strain as the loading continues. Using the microscope image data 400, the controller regularly determines the drift of the representative microscopic region 14′ and sends instructions 400′ to the adjustment device 22 accordingly. This feedback loop-based control process continues throughout the test. Device 24 performs stacking of the images obtained under vertical motion to build high quality frames of fully focused images. Likewise, Device 24 also performs the stitching of the images obtained under horizontal motion to obtain large panoramic views as needed. Device 26 (subsystem 200) is a set of algorithms that analyze the stacked images to determine evolution of various underlying characteristics of the local deformation such as microscopic local strain field, rigid body rotations, slip bands, crack initiations, and crack propagations and that of individual microstructural features. This is performed either real-time or post-test basis; Device 28 (subsystem 3) is an expert system to analyze, either real-time or post-test basis, the predetermined evolution characteristics and the image data 400 to determine the influence of the microstructure and its features on the local microscopic deformation, and elastic-plastic and failure properties. The three innovations proposed to be introduced as subsystems to this setup are as follows.

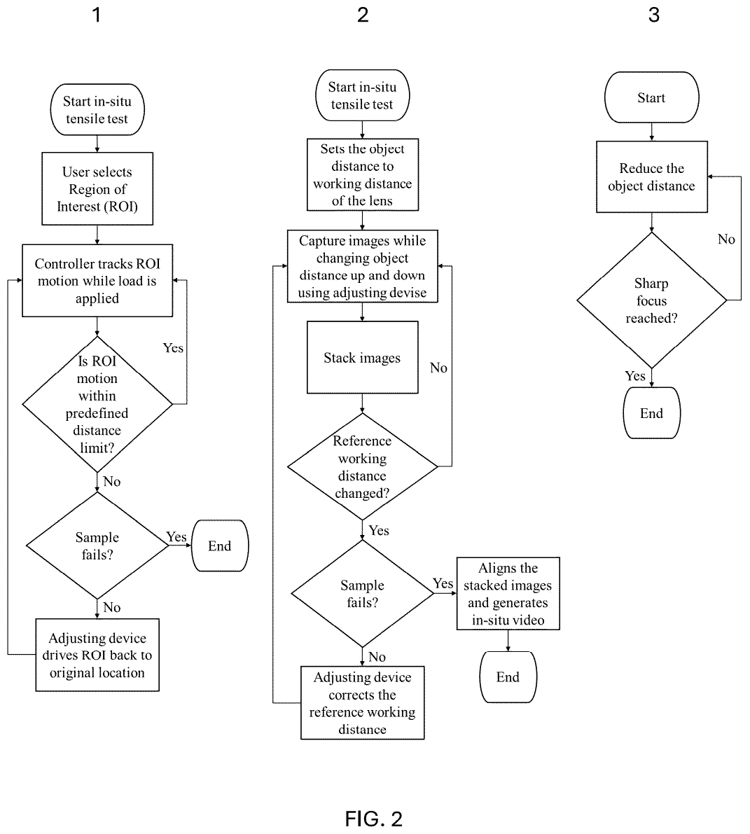

Smart imaging subsystem 100 (FIG. 2): As soon as the specimen 14 deforms under loading, the microscope 12 will lose focus due to the relatively low depth of field of the optical microscope and the target representative microscopic region 14′ from field of view due to its drifting in the horizontal plane due to deformation of the specimen. To maintain the focus and field of view, an intelligent automated subsystem is employed (FIG. 2). The subsystem comprised of a horizontal and vertical adjustment device 22, the micro tensile tester 16 mounted with the specimen, optical inverted microscope 12, and a controller 24. The controller receives the image data 400 from the microscope. A program embedded in the controller process the image data 400 and decide the motion input for the adjustment device to maintain the representative surface region to be imaged within the field of view horizontally and within the focus region vertically. To maintain horizontally (FIG. 2, flow chart 1), the movement of the microstructure is tracked using feature tracking algorithms, the horizontal drifting of the region from the field of view is computed, and using the computed values the micro tensile tester is repositioned such that the target region is back in the field of view. Maintaining focus vertically is extremely challenging since the large heterogeneity of the deformation produces an uneven specimen surface. Under such conditions, only partial regions of the representative region 14′ will be at focus leaving the remaining regions blurred. To address this challenge, a method is proposed (FIG. 2, flow chart 2). In this method, the distance between the specimen and the objective lens (object distance) is varied with a continuous up and down motion using adjustment device 22, collecting a series of images from different objective distances. Since the partial regions that are in focus change anytime the distance between the objective lens and the imaging plane (the specimen's surface) change, the images taken at different objective distances capture different partial regions in focus. Then, the well-focused partial regions from these frames are blended together to generate a single image with the whole region of interest fully focused; thus digitally enhancing the depth of field. That is, the technique introduces an effective depth of field for the microscope far greater than its inherent low depth of field. The Poisson's effect of the material also contributes to the vertical drifting of the specimen surface from the objective lens of the microscope, which is also accounted for in the maintaining of the imaging region in focus. To account for the drift due to Poisson's effect, the working distance is maintained by adjusting the distance of the objective lens from the specimen surface while checking the sharp focus of the image (FIG. 2, flow chart 3). The stacked image frames are aligned with each other to generate high quality in-situ videos either real-time or after the testing is completed.

In another embodiment, the ability of the device 22 to maintain the representative imaging region within the field of view horizontally is used for panoramic imaging to produce a field of view greater than that of the optical microscope. To accomplish this, throughout the testing, the device 22 will move the microtensile tester with the mounted specimen across the objective lens horizontally in a pre-determined path exposing a larger surface area of the specimen. The horizontal scanning across the pred-determined path will be repeated continuously as the loading progresses. The vertical distance adjustments to maintain distance between the specimen surface and the objective lens moved/maintained as needed will be performed as discussed in the previous embodiment. This method allows the microscope to scan across this larger area while taking images continuously; thus digitally enhancing the field of view. That is, the technique introduces an effective field of view for the microscope that is far greater than its inherent field of view. After the test is completed, the images are stacked vertically and stitched horizontally, thus providing the video of a fully focused large panoramic region.

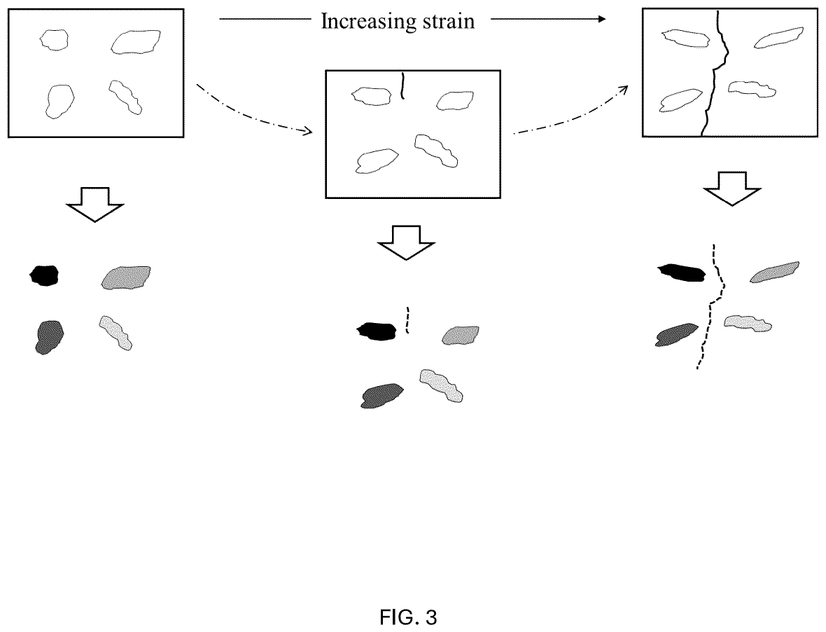

Deformation quantification subsystem 200: (FIG. 3) This subsystem will process the stream of images and quantitatively determine the deformation of microstructural features using algorithms based on the principles of advanced vision science. First, it will identify and group the microstructural features that are critical in terms of their potential to influence mechanical properties based on their various geometrical and mechanical characteristics. Then their motions/evolutions will be tracked following their group signatures. For feature detection, advanced feature recognition algorithms may be used, such as, for example, Shi-Tomasi (C., & Detection, T. K. (1991). Tracking of point features. Tech. Rep. CMU-CS-91-132, Carnegie Mellon University), Scale-Invariant Feature Transform (SIFT) (Object tracking using SIFT and KLT tracker for UAV-based applications. In 2015 IEEE International Symposium on Robotics and Intelligent Sensors (IRIS) (pp. 65-68). IEEE) and Speeded-Up Robust Features (SURF) (Surf: Speeded up robust features. In European conference on computer vision (pp. 404-417). Springer, Berlin, Heidelberg). For tracking, optical flow-based feature tracking algorithms are used, such as, for example, Kanade-Lucas-Tomasi (Multi-cue onboard pedestrian detection. In 2009 IEEE Conference on Computer Vision and Pattern Recognition (pp. 794-801). IEEE). The specific characteristics of the local deformation that of interest to determine the influence of microstructure on elastic-plastic properties include local strain field, deformation of individual grains/sub-grain features such as their dilatation, distortion, and rotation, evolution of shear bands and slip lines, micro-twins distribution, and more importantly the localization of these quantities around different microstructural feature boundaries. To determine failure properties, the characteristics of interest are the crack nucleation and propagation in the microstructure.

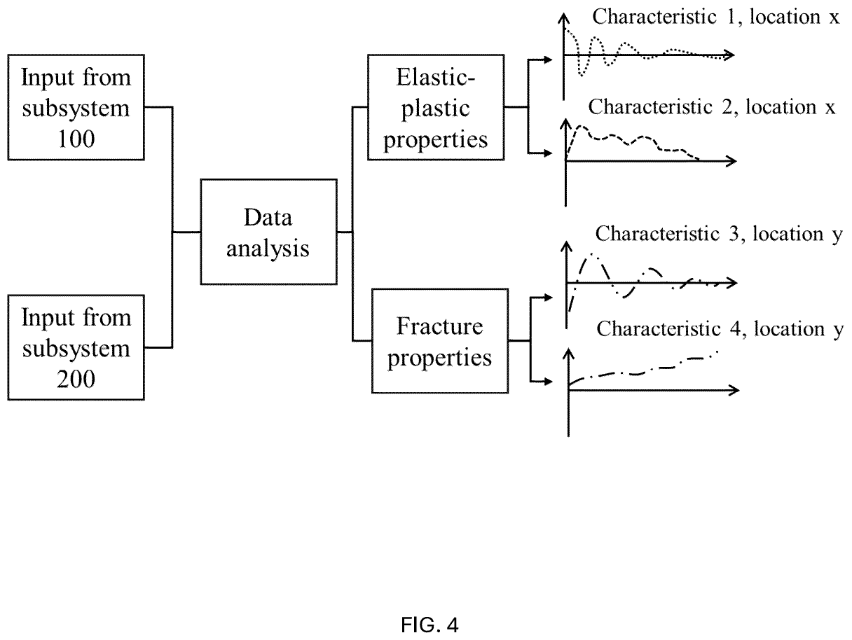

Material modeling subsystem 300: (FIG. 4) This subsystem is an expert system that determines the influence of microstructure on elastic-plastic and failure properties by analyzing the quantified local deformation characteristics from subsystem 200. The expert system will compare various characteristics (e.g., slip band density, strain localization, localization of rotations etc. (presented in the FIG. 4 as characteristic 1, 2, etc.) at different locations of the microstructure (presented in FIG. 4 as locations, x, y etc.) to derive correlations between these behaviors and the underlying microstructural features at these locations. The expert system will use machine learning algorithms and other physics-based modeling tools to derive these correlations; the individual and collective influence of various microstructural features with the elastic-plastic such as strengths and strain-hardening rate. The expert system will also do the same process to derive the individual and collective influence of various microstructural features with the fracture properties such as ductility by comparing the evolution of characteristics crack nucleation and crack propagation.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A testing system for characterizing heterogeneous deformation at microscale, comprising:
a. a specimen on which the testing is conducted and having a bottom surface including a representative microscopic region thereon and a top surface with reference markings formed thereon;
b. a load imparting device for imparting a tensile load to the specimen;
c. a microscope adapted to capture data representative of local deformations formed in the microscopic region of the specimen as it undergoes the loading imparted by the device;
d. a camera for digitally capturing a stream of image data by tracking the reference markings, wherein the image data is representative of the macroscopic strain caused to the specimen as it undergoes the loading imparted by the device;
e. an adjustment device adapted to move the device; and
f. a microprocessor having a non-transitory memory and programmed, configured, and/or structured to:
control movement of the adjustment device;
process the image data captured by the camera and determine the deformation of the microstructural features; and
determine the influence of microstructure on elastic-plastic and failure properties based on predetermined characteristics of local deformation and microstructural features.

2. The system according to claim 1, wherein the load imparting device is a micro-tensile testing machine.

3. The system according to claim 1, wherein the microscope is an optical inverted microscope.

4. The system according to claim 1, wherein the adjustment device is adapted to move horizontally with respect to the microscope.

5. The system according to claim 3, wherein the horizontal movement is configured to capture a panoramic image.

6. The system according to claim 1, wherein the adjustment device is adapted to move vertically with respect to the microscope.

7. The system according to claim 5, wherein the vertical movement is cyclic.

8. The system according to claim 1, wherein the load imparted to the specimen can comprise tension, compression, bending, or a combination thereof.

9. A method for characterizing heterogeneous deformation at microscale, comprising the steps of:
a. providing a specimen on which the testing is conducted and having a bottom surface including a representative microscopic region thereon and a top surface with reference markings formed thereon;
b. providing a device for imparting a load to the specimen;
c. providing a microscope adapted to capture data representative of local deformations formed in the microscopic region of the specimen as it undergoes the loading imparted by the device;
d. providing a camera for digitally capturing a stream of image data by tracking the reference markings, wherein the image data is representative of the macroscopic strain caused to the specimen as it undergoes the loading imparted by the device;
e. providing an adjustment device adapted to move the device;
f. controlling movement of the adjustment device;
g. processing the image data captured by the camera and quantify the macroscopic strain; and
h. determining the influence of microstructure on elastic-plastic and failure properties based on predetermined characteristics of local deformation and microstructural features.

10. A computer program stored in the memory of a microprocessor having a non-volatile memory, wherein the microprocessor is electronically connected to a system for characterizing heterogeneous deformation at microscale that includes a specimen on which the testing is conducted and having a bottom surface including a representative microscopic region thereon and a top surface with reference markings formed thereon; a device for imparting a load to the specimen; a microscope adapted to capture data representative of local deformations formed in the microscopic region of the specimen as it undergoes the loading imparted by the device; a camera for digitally capturing a stream of image data by tracking the reference markings, wherein the image data is representative of the macroscopic strain caused to the specimen as it undergoes the loading imparted by the device; and an adjustment device adapted to move the device, the computer program containing computer readable instructions adapted to:
a. control movement of the adjustment device;
b. process the image data captured by the camera and quantify the macroscopic strain; and
c. determine the influence of microstructure on elastic-plastic and failure properties based on predetermined characteristics of local deformation and microstructural features.

11. The computer program of claim 10, wherein the instructions are further adapted to:
a. process the image data captured by the microscope and quantity a drift of the representative microscopic region from a field of view horizontally;
b. instruct the adjusting device to perform an adjustment horizontally to maintain a target imaging region within the field of view following a closed loop control architecture using the calculated drift information from the image data as feedback;
c. drive a continuous cyclic motion of the adjustment device to vary a focal distance between an imaging surface and an objective lens to capture images from different focal distances that contain different partial regions under focus;
d. process the image data captured by the microscope at different vertical distances to quantity a glare in the image;
e. drive the adjustment device to perform an adjustment vertically to maintain the target imaging region within focus following the closed loop control architecture using the glare information as feedback;
f. perform a blending of images obtained under vertical motion;
g. drive the adjustment device to perform a pre-determined horizontal motion to capture panoramic imaging
h. perform blending of the images obtained under the horizontal motion to obtain panoramic views; and
i. perform a data analysis of the blended images to determine an evolution of the characteristics of the local deformation and the deformation of individual microstructural features.
